(19) United States
(12) Patent Application Publication
(10) Pub. No.: US 2021/0362727 A1
(43) Pub. Date: Nov. 25, 2021

(54) SHARED VEHICLE MANAGEMENT DEVICE AND MANAGEMENT METHOD FOR SHARED VEHICLE

(71) Applicant: LG ELECTRONICS INC., Seoul (KR)

(72) Inventors: Soryoung KIM, Seoul (KR); Chiwon SONG, Seoul (KR)

(73) Assignee: LG ELECTRONICS INC., Seoul (KR)

(21) Appl. No.: 16/500,758

(22) PCT Filed: Jul. 4, 2019
(86) PCT No.: PCT/KR2019/008206

§ 371 Date: Oct. 3, 2019

(51) Int. Cl. B60W 40/09; G06Q 50/26; G06Q 50/30; B60W 60/00; B60W 50/14

(52) U.S. Cl. CPC B60W 40/09; G06Q 50/265; G06Q 50/30; B60W 2540/30; B60W 60/0051; B60W 60/0059; B60W 50/14; B60W 60/0015

(57) ABSTRACT

The present invention relates to a management method for a shared vehicle including the steps of: receiving, by at least one processor, a vehicle allocation request signal; determining, by at least one processor, an allocated vehicle based on first traveling path information included in the vehicle allocation request signal; authenticating, by at least one processor, driving qualification of a user for a manned autonomous vehicle when the manned autonomous vehicle is determined to be the allocated vehicle; and providing, by at least one processor, a passenger-assistance autonomous vehicle option. A shared vehicle management device can manage an autonomous vehicle. The autonomous vehicle may be linked to a robot. The shared vehicle management device may be implemented through an artificial intelligence algorithm. The shared vehicle management device may produce augmented reality (AR) contents.

### TECHNICAL FIELD

The present invention relates to a shared vehicle management device and a management method for a shared vehicle.

### BACKGROUND ART

A vehicle is an apparatus movable in a desired direction by a user seated therein. A representative example of such a vehicle is an automobile. In accordance with demand in markets for shared vehicles, differently from existing vehicles of a possession concept, development is being conducted as to shared vehicles. Service providing companies providing shared vehicles are being established.

In accordance with a situation of a requester, a manual vehicle or an autonomous vehicle may be provided as a shared vehicle. Even when an autonomous vehicle is provided, manual traveling may be required in a specific situation or in a particular section. In this case, there is a problem in that a service providing company should provide the autonomous vehicle under the condition that a driver exclusive for the autonomous vehicle should be employed.

### DISCLOSURE

### Technical Problem

Therefore, the present invention has been made in view of the above problems, and it is an object of the present invention to provide a shared vehicle management device configured to provide a passenger-assistance autonomous vehicle option when the user of an autonomous vehicle has a manual traveling ability.

It is another object of the present invention to provide a management method for a shared vehicle configured to provide a passenger-assistant autonomous vehicle option when the user of an autonomous vehicle has a manual traveling ability.

Objects of the present invention are not limited to the above-described objects, and other objects of the present invention not yet described will be more clearly understood by those skilled in the art from the following detailed description.

### Technical Solution

In accordance with an aspect of the present invention, the above objects can be accomplished by the provision of a management method for a shared vehicle including the steps of: receiving, by at least one processor, a vehicle allocation request signal; determining, by at least one processor, a vehicle to be allocated based on first traveling path information included in the vehicle allocation request signal; authenticating, by at least one processor, driving qualification of a user for a manned autonomous vehicle when the manned autonomous vehicle is determined to be a vehicle to be allocated; and providing, by at least one processor, a passenger-assistance autonomous vehicle option.

In accordance with an embodiment of the present invention, the management method for the shared vehicle may further include: determining, by at least one processor, a pick-up point of the user; and acquiring, by at least one processor, information as to a second traveling path from a start point of the vehicle to the pick-up point.

In accordance with an embodiment of the present invention, the providing step may provide the passenger-assistance autonomous vehicle option when a danger level of the second traveling path is not to be higher than a reference value.

In accordance with an embodiment of the present invention, the management method for the shared vehicle may further include the steps of: acquiring, by at least one processor, state information of the user; and determining, by at least one processor, whether the user is able to perform driving, based on the state information.

In accordance with an embodiment of the present invention, the providing step may provide the passage-assistance autonomous vehicle option when the user is determined to be able to perform driving.

In accordance with an embodiment of the present invention, the management method for the shared vehicle may further include: the step of providing, by at least one processor, a manned autonomous vehicle option when driving qualification of the user is determined not to be authenticated.

In accordance with an embodiment of the present invention, the step of determining a vehicle to be allocated may include the steps of: determining, by at least one processor, a danger level of the first traveling path; and determining, by at least one processor, a vehicle to be allocated, based on which level from among a plurality of predetermined levels corresponds to the danger level of the first traveling path.

In accordance with an embodiment of the present invention, the driving qualification authenticating step may include authenticating, by at least one processor, a manual driver license of the user, and the providing step may provide a passenger-assistance autonomous vehicle option when the manual driver license is authenticated.

In accordance with an embodiment of the present invention, the driving qualification authenticating step may include the steps of determining, by at least one processor, whether the user has completed a driving-assistance tutorial course, and issuing, by at least one processor, a driving allowance grade for a part of sections in association with the user, and the providing step may provide a passenger-assistance autonomous vehicle option when the user is determined to have completed a driving-assistance tutorial course.

In accordance with an embodiment of the present invention, the management method for the shared vehicle may further include providing, by at least one processor, an information message as to a cause of requirement of driving of a passenger, and the information message may include at least one of a message informing of verification of updated software, a message informing of an update situation of software, a message informing of a section exhibiting a high probability of sensor malfunction, or a message informing of a communication shadow section.

In accordance with an embodiment of the present invention, the management method for the shared vehicle may further include the step of resetting, by at least one processor, i) a path exhibiting a highest capability of unmanned autonomous travel from a deviated point to a destination or ii) a rapidest autonomous path from the deviated point to the destination when the vehicle is determined to deviate from a predetermined autonomous path due to manual driving of the user.

In accordance with another aspect of the present invention, the above objects can be accomplished by the provision of a shared vehicle management device including: at least one processor for receiving a vehicle allocation request signal, determining a vehicle to be allocated based on first traveling path information included in the vehicle allocation request signal, authenticating driving qualification of a user for a manned autonomous vehicle when the manned autonomous vehicle is determined to be a vehicle to be allocated, and providing a passenger-assistance autonomous vehicle option.

In accordance with an embodiment of the present invention, the processor may determine a pick-up point of the user, and may acquire information as to a second traveling path from a start point of the vehicle to the pick-up point.

In accordance with an embodiment of the present invention, the processor may provide the passenger-assistance autonomous vehicle option when a danger level of the second traveling path is not to be higher than a reference value.

In accordance with an embodiment of the present invention, the processor may acquire state information of the user, may determine whether the user is able to perform driving, based on the state information, and may provide the passage-assistance autonomous vehicle option when the user is determined to be able to perform driving.

In accordance with an embodiment of the present invention, the processor may provide a manned autonomous vehicle option when driving qualification of the user is determined not to be authenticated.

In accordance with an embodiment of the present invention, the processor may determine a danger level of the first traveling path, and may determine a vehicle to be allocated, based on which level from among a plurality of predetermined levels corresponds to the danger level of the first traveling path.

In accordance with an embodiment of the present invention, the processor may authenticate a manual driver license of the user, and may provide a passenger-assistance autonomous vehicle option when the manual driver license is authenticated.

In accordance with an embodiment of the present invention, the processor may determine whether the user has completed a driving-assistance tutorial course, may issue a driving allowance grade for a part of sections in association with the user, and may provide a passenger-assistance autonomous vehicle option when the user is determined to have completed a driving-assistance tutorial course.

In accordance with an embodiment of the present invention, the processor may provide an information message as to a cause of requirement of driving of a passenger, and the information message may include at least one of a message informing of verification of updated software, a message informing of an update situation of software, a message informing of a section exhibiting a high probability of sensor malfunction, or a message informing of a communication shadow section.

In accordance with an embodiment of the present invention, the processor may reset i) a path exhibiting a highest capability of unmanned autonomous travel from a deviated point to a destination or ii) a rapidest autonomous path from the deviated point to the destination when the vehicle is determined to deviate from a predetermined autonomous path due to manual driving of the user.

Concrete matters of other embodiments will be apparent from the detailed description and the drawings.

### Advantageous Effects

In accordance with the present invention, one or more effects are provided as follows.

First, there is an effect of reducing driver employment costs of a service providing company.

Second, there is an effect of enhancing a driving rate of an autonomous vehicle requiring a driver or monitoring.

Third, there is an effect of reducing service utilization costs of the user.

Fourth, there is an effect of reducing a vehicle allocation standby time in accordance with an increase in driving rate.

The effects of the present invention are not limited to the above-described effects and other effects which are not described herein may be derived by those skilled in the art from the following description of the embodiments of the disclosure.

### DESCRIPTION OF DRAWINGS

FIG. 1 is a configuration diagram of a system according to an embodiment of the present invention.

FIG. 2 is a control block diagram of a vehicle according to an embodiment of the present invention.

FIG. 3 is a control block diagram of a shared vehicle management device according to an embodiment of the present invention.

FIG. 4 is a diagram referred to for explanation of the system according to an embodiment of the present invention.

FIG. 5 is a flowchart referred to for explanation of a management method for a shared vehicle according to an embodiment of the present invention.

FIG. 6 is a flowchart referred to for explanation of a management method for a shared vehicle according to an embodiment of the present invention.

### BEST MODE

Reference will now be made in detail to the exemplary embodiments of the present invention, examples of which are illustrated in the accompanying drawings. Identical or similar constituent elements will be designated by the same reference numeral even though they are depicted in different drawings. The suffixes “module” and “unit” of elements herein are used for convenience of description and thus can be used interchangeably, and do not have any distinguishable meanings or functions. In the following description of the at least one embodiment, a detailed description of known functions and configurations incorporated herein will be omitted for the purpose of clarity and for brevity. The features of the present invention will be more clearly understood from the accompanying drawings and should not be limited by the accompanying drawings, and it is to be appreciated that all changes, equivalents, and substitutes that do not depart from the spirit and technical scope of the present invention are encompassed in the present invention.

It will be understood that, although the terms “first”, “second”, “third” etc. may be used herein to describe various elements, these elements should not be limited by these terms. These terms are only used to distinguish one element from another element.

It will be understood that, when an element is referred to as being “connected to” or “coupled to” another element, it may be directly connected or coupled to the other element, or intervening elements may be present. In contrast, when an element is referred to as being “directly connected to” or “directly coupled to” another element or layer, there are no intervening elements present.

The singular expressions in the present specification include the plural expressions unless clearly specified otherwise in context.

It will be further understood that the terms “comprises” or “comprising” when used in this specification specify the presence of stated features, integers, steps, operations, elements, or components, but do not preclude the presence or addition of one or more other features, integers, steps, operations, elements, components, or groups thereof.

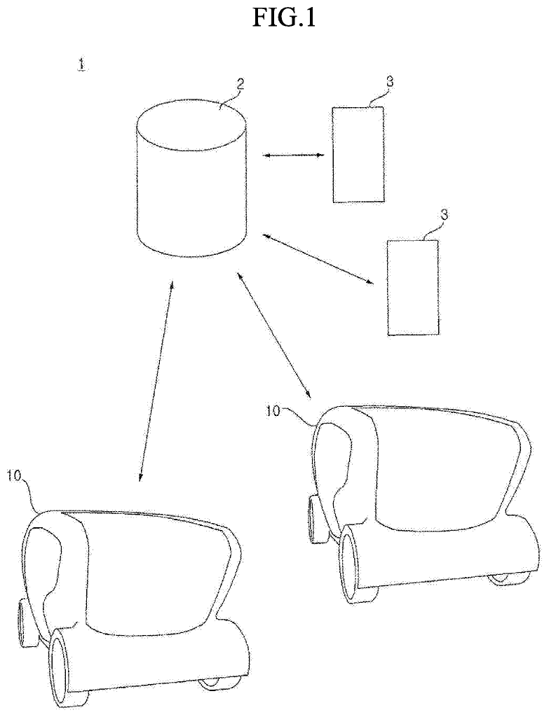

FIG. 1 is a configuration diagram of a system according to an embodiment of the present invention.

Referring to FIG. 1, the system 1 may provide a shared vehicle 10 to the user. The system 1 may include a shared vehicle management device 2, at least one user terminal 3, and at least one shared vehicle 10.

The shared vehicle management device 2 may be embodied using at least one server. The shared vehicle management device 2 may allocate the shared vehicle 10 in accordance with a request signal through the user terminal 3. The shared vehicle management device 2 may allocate the shared vehicle 10 based on information included in the request signal.

The user terminal 3 may be defined as a terminal possessed by the user. The user terminal 3 may be a terminal personally usable by the user, such as a smartphone, a tablet PC, a desktop, or a laptop. The user terminal 3 may include an interface device and a communication device. The user terminal 3 may receive user input requesting a shared vehicle through the interface device. The user terminal 3 may transmit a shared vehicle request signal through the communication device. The shared vehicle request signal may include information as to a path requested by the user. The information as to the path requested by the user may include information as to a pick-up point of the user and a destination of the user.

The shared vehicle 10 may be at least one of a manual vehicle or an autonomous vehicle. The shared vehicle 10 may be at least one of a manned manual vehicle, a manned autonomous vehicle, a fully autonomous vehicle, or a passenger-assistance autonomous vehicle. The manned manual vehicle may be a manual vehicle including a driver provided by a service providing company. The manned autonomous vehicle may be an autonomous vehicle including a driver provided by a service providing company. The fully autonomous vehicle may be an autonomous vehicle including no driver. The passenger-assistance autonomous vehicle may be an autonomous vehicle or a vehicle driven by the passenger or driving-assisted by the passenger.

Meanwhile, the vehicle 10 according to the embodiment of the present invention is defined as a transportation means to travel on a road or a railway line. The vehicle 10 is a concept including an automobile, a train, and a motorcycle. The vehicle 10 may be a concept including all of an internal combustion engine vehicle including an engine as a power source, a hybrid vehicle including an engine and an electric motor as a power source, an electric vehicle including an electric motor as a power source, etc.

An electronic device 100 may be included in the vehicle 10. The electronic device 100 may be included in the vehicle, for interaction thereof with the shared vehicle management device 2.

Meanwhile, the vehicle 10 may co-operate with at least one robot. The robot may be an autonomous mobile robot (AMR) which is autonomously movable. The mobile robot is configured to be autonomously movable and, as such, is freely movable. The mobile robot may be provided with a plurality of sensors to enable the mobile robot to bypass an obstacle during travel and, as such, may travel while bypassing obstacles. The mobile robot may be a flying robot (for example, a drone) including a flying device. The mobile robot may be a wheeled robot including at least one wheel, to move through rotation of the wheel. The mobile robot may be a leg type robot including at least one leg, to move using the leg.

The robot may function as an apparatus for supplementing convenience of the user of the vehicle 10. For example, the robot may perform a function for transporting a load carried in the vehicle 10 to a user's final destination. For example, the robot may perform a function for guiding a way to a final destination to the user having exited the vehicle 10. For example, the robot may perform a function for transporting the user having exited the vehicle 10 to a final destination.

At least one electronic device included in the vehicle may perform communication with the robot through a communication device 220.

At least one electronic device included in the vehicle may provide, to the robot, data processed in at least one electronic device included in the vehicle. For example, at least one electronic device included in the vehicle may provide, to the robot, at least one of object data, HD map data, vehicle state data, vehicle position data or driving plan data.

At least one electronic device included in the vehicle may receive, from the robot, data processed in the robot. At least one electronic device included in the vehicle may receive at least one of sensing data produced in the robot, object data, vehicle state data, vehicle position data or driving plan data produced from the robot.

At least one electronic device included in the vehicle may generate a control signal further based on data received from the robot. For example, at least one electronic device included in the vehicle may compare information as to an object produced in an object detection device 210 with information as to an object produced by the robot, and may generate a control signal based on compared results. At least one electronic device included in the vehicle may generate a control signal in order to prevent interference between a travel path of the vehicle 10 and a travel path of the robot.

At least one electronic device included in the vehicle may include a software module or a hardware module (hereinafter, an artificial intelligence (AI) module) realizing artificial intelligence. At least one electronic device included in the vehicle may input acquired data to the artificial intelligence module, and may use data output from the artificial intelligence module.

The artificial intelligence module may execute machine learning of input data, using at least one artificial neural network (ANN). The artificial intelligence module may output driving plan data through machine learning of input data.

At least one electronic device included in the vehicle may generate a control signal based on data output from the artificial intelligence module.

In accordance with an embodiment, at least one electronic device included in the vehicle may receive data processed through artificial intelligence from an external device via the communication device 220. At least one electronic device included in the vehicle may generate a control signal based on data processed through artificial intelligence.

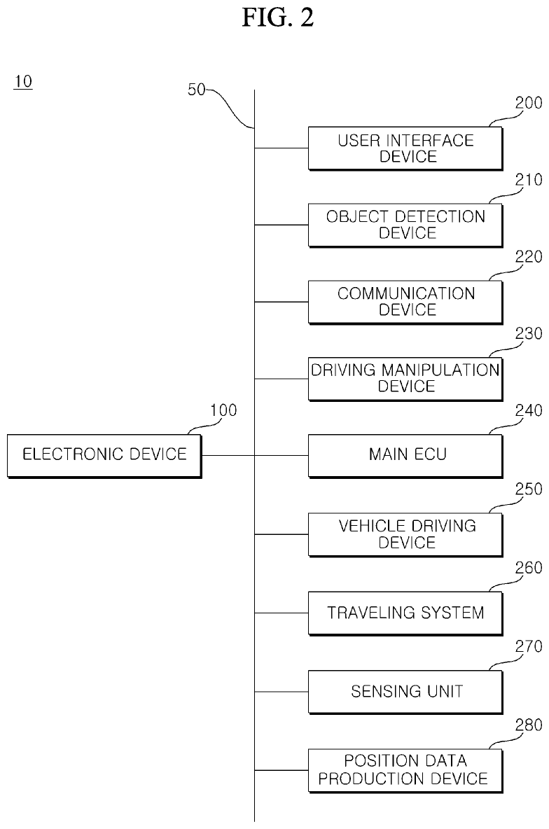

FIG. 2 is a control block diagram of the vehicle according to an embodiment of the present invention.

Referring to FIG. 2, the vehicle 10 may include the vehicle electronic device 100, a user interface device 200, the object detection device 210, the communication device 220, a driving manipulation device 230, a main electronic control unit (ECU) 240, a vehicle driving device 250, a traveling system 260, a sensing unit 270, and a position data production device 280.

The vehicle electronic device 100 may exchange a signal, information or data with the shared vehicle management device 2 through the communication device 220. The vehicle electronic device 100 may provide a signal, information or data received from the shared vehicle management device 2 to other electronic devices in the vehicle 10.

The user interface device 200 is a device for enabling communication between the vehicle 10 and the user. The user interface device 200 may receive user input, and may provide information produced in the vehicle 10 to the user. The vehicle 10 may realize user interface (UI) or user experience (UX) through the user interface device 200.

The object detection device 210 may detect an object outside the vehicle 10. The object detection device 210 may include at least one sensor capable of detecting an object outside the vehicle 10. The object detection device 210 may include at least one of a camera, a radar, a lidar, an ultrasound sensor or an infrared sensor. The object detection device 210 may provide data as to an object produced based on a sensing signal generated in the sensor to at least one electronic device included in the vehicle.

The camera may produce information as to an object outside the vehicle 10, using an image. The camera may include at least one lens, at least one image sensor, and at least one processor electrically connected to the image sensor, to process a signal received from the image sensor and to produce data as to an object based on the processed signal.

The camera may be at least one of a mono camera, a stereo camera, or an around view monitoring (AVM) camera. Using various image processing algorithms, the camera may acquire position information of an object, information as to a distance from the object or information as to a relative speed with respect to the object. For example, the camera may acquire information as to a distance from an object and information as to a relative speed with respect to the object from an acquired image, based on a variation in the size of the object according to time. For example, the camera may acquire distance information and relative speed information associated with an object through a pin hole model, road surface profiling, etc. For example, the camera may acquire distance information and relative speed information associated with an object from a stereo image acquired in a stereo camera, based on disparity information.

In order to photograph an outside of the vehicle, the camera may be mounted at a position in the vehicle where the camera can secure a field of view (FOV). In order to acquire an image in front of the vehicle, the camera may be disposed in an inner compartment of the vehicle in the vicinity of a front windshield. The camera may be disposed around a front bumper or a radiator grill. In order to acquire an image in rear of the vehicle, the camera may be disposed in the inner compartment of the vehicle in the vicinity of a rear glass. The camera may be disposed around a rear bumper, a trunk or a tail gate. In order to acquire an image at a lateral side of the vehicle, the camera may be disposed in the inner compartment of the vehicle in the vicinity of at least one of side windows. Alternatively, the camera may be disposed around a side mirror, a fender, or a door.

The radar may produce information as to an object outside the vehicle 10 using a radio wave. The radar may include an electromagnetic wave transmitter, an electromagnetic wave receiver, and at least one processor electrically connected to the electromagnetic wave transmitter and the electromagnetic wave receiver, to process a received signal and to produce data as to an object based on the processed signal. The radar may be embodied through a pulse radar system or a continuous wave radar system based on a radio wave emission principle. The radar may be embodied through a frequency modulated continuous wave (FMCW) system or a frequency shift keyong (FSK) system selected from continuous wave radar systems in accordance with a signal waveform. The radar may detect an object, a position of the detected object, and a distance and a relative speed with respect to the detected object by means of an electromagnetic wave on the basis of time of flight (TOF) or phase shift. The radar may be disposed at an appropriate position outside the vehicle in order to sense an object disposed at a front, rear or lateral side of the vehicle.

The lidar may produce information as to an object outside the vehicle 10, using laser light. The lidar may include an optical transmitter, an optical receiver, and at least one processor electrically connected to the optical transmitter and the optical receiver, to process a received signal and to produce data as to an object based on the processed signal. The lidar may be embodied through a time-of-flight (TOF) system and a phase shift system. The lidar may be implemented in a driven manner or a non-driven manner. When the lidar is implemented in a driven manner, the lidar may detect an object around the vehicle 10 while being rotated by a motor. When the lidar is implemented in a non-driven manner, the lidar may detect an object disposed within a predetermined range with reference to the vehicle by optical steering. The vehicle 10 may include a plurality of non-driven lidars. The lidar may detect an object, a position of the detected object, and a distance and a relative speed with respect to the detected object by means of laser light on the basis of time of flight (TOF) or phase shift. The lidar may be disposed at an appropriate position outside the vehicle in order to sense an object disposed at a front, rear or lateral side of the vehicle.

The communication device 220 may exchange a signal with a device disposed outside the vehicle 10. The communication device 220 may exchange a signal with at least one of infrastructure (for example, a server or a broadcasting station) or another vehicle. The communication device 220 may include at least one of a transmission antenna, a reception antenna, a radio frequency (RF) circuit or an RF element capable of implementing various communication protocols in order to execute communication.

The communication device 220 may communicate with a device disposed outside the vehicle 10, using a 5G (for example, new radio (NR)) system. The communication device 220 may implement V2X (V2V, V2D, V2P or V2N) communication using the 5G system.

The driving manipulation device 230 is a device for receiving user input for driving. In a manual mode, the vehicle 10 may be driven based on a signal provided by the driving manipulation device 230. The driving manipulation device 230 may include a steering input device (for example, a steering wheel), an acceleration input device (for example, an accelerator pedal), and a brake input device (for example, a brake pedal).

The main ECU 240 may control overall operation of at least one electronic device included in the vehicle 10.

The driving control device 250 is a device for electrically controlling various vehicle driving devices in the vehicle 10. The driving control device 250 may include a powertrain driving control device, a chassis driving control device, a door/window driving control device, a safety device driving control device, a lamp driving control device, and an air conditioner driving control device. The powertrain driving control device may include a power source driving control device and a transmission driving control device. The chassis driving control device may include a steering driving control device, a brake driving control device, and a suspension driving control device.

Meanwhile, the safety device driving control device may include a safety belt driving control device for safety belt control.

The vehicle driving control device 250 may be referred to as a “control electronic control unit (ECU)”.

The traveling system 260 may control motion of the vehicle 10 or may generate a signal for outputting information to the user, based on data as to an object received from the object detection device 210. The traveling system 260 may provide the generated signal to at least one of the user interface device 200, the main ECU 240 or the vehicle driving device 250.

The traveling system 260 may be a concept including an advanced driver-assistance system (ADAS). The ADAS 260 may embody an adaptive cruise control (ACC) system, an autonomous emergency braking (AEB) system, a forward collision warning (FCW) system, a lane keeping assist (LKA) system, a lane change assist (LCA) system, a target following assist (TFA) system, a blind sport detection (BSD) system, an adaptive high beam assist (HBA) system, an auto-parking system (APS), a pedestrian (PD) collision warning system, a traffic sign recognition (TSR) system, a traffic sign assist (TSA) system, a night vision (NV) system, a driver status monitoring (DSM) system, or a traffic jam assist (TJA) system.

The traveling system 260 may include an autonomous electronic control unit (ECU). The autonomous ECU may set an autonomous travel path based on data received from at least one of other electronic devices in the vehicle 10. The autonomous ECU may set an autonomous travel path based on data received from at least one of the user interface device 200, the object detection device 210, the communication device 220, the sensing unit 270, or the position data production device 280. The autonomous traveling ECU may generate a control signal to enable the vehicle 10 to travel along the autonomous travel path. The control signal generated from the autonomous traveling ECU may be provided to at least one of the main ECU 240 or the vehicle driving device 250.

The sensing unit 270 may sense a state of the vehicle. The sensing unit 270 may include at least one of an inertial navigation unit (INU) sensor, a collision sensor, a wheel sensor, a speed sensor, a slope sensor, a weight sensor, a heading sensor, a position module, a vehicle forward/backward movement sensor, a battery sensor, a fuel sensor, a tire sensor, a handle-rotation-based steering sensor, an internal vehicle temperature sensor, an internal vehicle humidity sensor, an ultrasonic sensor, an ambient light sensor, an accelerator pedal position sensor, or a brake pedal position sensor. Meanwhile, the inertial navigation unit (INU) sensor may include at least one of an acceleration sensor, a gyro sensor, or a magnetic sensor.

The sensing unit 270 may produce vehicle state data based on a signal generated from at least one sensor. The sensing unit 270 may acquire sensing signals as to vehicle posture information, vehicle motion information, vehicle yaw information, vehicle roll information, vehicle pitch information, vehicle collision information, vehicle direction information, vehicle angle information, vehicle speed information, vehicle acceleration information, vehicle inclination information, vehicle forward/backward movement information, battery information, fuel information, tire information, vehicle lamp information, internal vehicle temperature information, internal vehicle humidity information, a steering wheel rotation angle, ambient illumination outside the vehicle, a pressure applied to the accelerator pedal, a pressure applied to the brake pedal, etc.

In addition, the sensing unit 270 may further include an accelerator pedal sensor, a pressure sensor, an engine speed sensor, an air flow sensor (AFS), an intake air temperature sensor (ATS), a water temperature sensor (WTS), a throttle position sensor (TPS), a top dead center (TDC) sensor, a crank angle sensor (CAS), etc.

The sensing unit 270 may produce vehicle state information based on sensing data. The vehicle state information may be information produced based on data sensed by various sensors included in the vehicle.

For example, the vehicle state information may include vehicle posture information, vehicle speed information, vehicle inclination information, vehicle weight information, vehicle direction information, vehicle battery information, vehicle fuel information, vehicle tire air pressure information, vehicle steering information, internal vehicle temperature information, internal vehicle humidity information, pedal position information, vehicle engine temperature information, etc.

Meanwhile, the sensing unit may include a tension sensor. The tension sensor may generate a sensing signal based on a tension state of a safety belt.

The position data production device 280 may produce position data of the vehicle 10. The position data production device 280 may include at least one of a global positioning system (GPS) or a differential global positioning system (DGPS). The position data production device 280 may produce position data of the vehicle 10 based on a signal generated from at least one of the GPS or the DGPS. In accordance with an embodiment, the position data production device 280 may correct position data based on at least one of an inertial measurement unit (IMU) of the sensing unit 270 or a camera of the object detection device 210.

The position data production device 280 may be referred to as a “position measurement device”. The position data production device 280 may be referred to as a “global navigation satellite system (GNSS)”.

The vehicle 10 may include an inner communication system 50. Plural electronic devices included in the vehicle 10 may exchange a signal via the inner communication system 50. Data may be included in the signal. The inner communication system 50 may utilize at least one communication protocol (for example, CAN, LIN, FlexRay, MOST, or Ethernet).

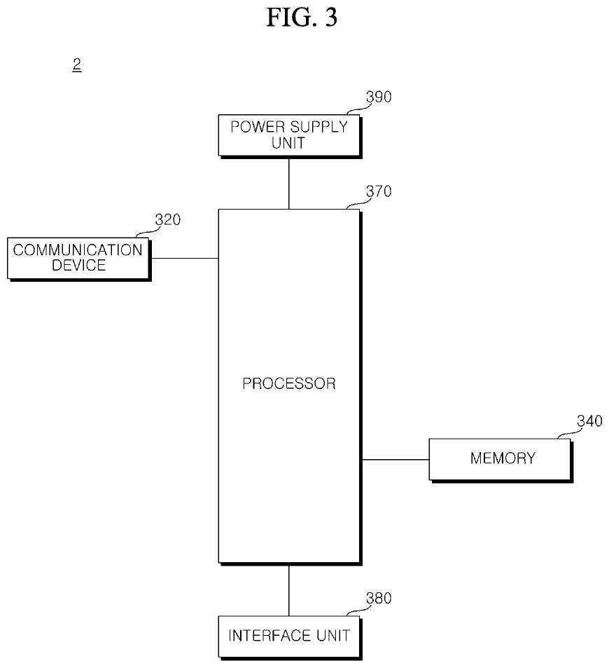

FIG. 3 is a control block diagram of the shared vehicle management device according to an embodiment of the present invention.

Referring to FIG. 3, the shared vehicle management device 2 may include a communication device 320, a memory 340, a processor 370, an interface unit 380, and a power supply unit 390.

The communication device 320 may exchange a signal with the vehicle 10 and the user terminal 3. The communication device 220 may include at least one of a transmission antenna, a reception antenna, a radio frequency (RF) circuit or an RF element capable of implementing various communication protocols in order to execute communication.

The communication device 320 may communicate with the vehicle 10 and the user terminal 3, using a 5G (for example, new radio (NR)) system.

The memory 340 is electrically connected to the processor 370. The memory 340 may store basic data as to units, control data for unit operation control, and input and output data. The memory 340 may store data processed by the processor 370. The memory 340 may be constituted in a hardware manner by at least one of a read only memory (ROM), a random access memory (RAM), an erasable programmable read-only memory (EPROM), a flash drive, or a hard drive. The memory 340 may store various data for overall operation of the shared vehicle management device 100 including a program for processing or controlling the processor 370, etc. The memory 340 may be embodied as being integrated with the processor 370. In accordance with an embodiment, the memory 340 may be classified into a lower-level configuration of the processor 370.

The interface unit 380 may exchange a signal with at least one electronic device included in the vehicle 10 in a wired or wireless manner. The interface unit 380 may exchange a signal in a wired or wireless manner with at least one of the object detection device 210, the communication device 220, the driving manipulation device 230, the main ECU 140, the vehicle driving device 250, the ADAS 260, the sensing unit 370, or the position data production device 280. The interface unit 380 may be constituted by at least one of a communication module, a terminal, a pin, a cable, a port, a circuit, an element, or a device.

The interface unit 380 may receive position data of the vehicle 10 from the position data production device 280. The interface unit 380 may receive travel speed data from the sensing unit 270. The interface unit 380 may receive vehicle surrounding object data from the object detection device 210.

The power supply unit 390 may supply electric power to the shared vehicle management device 100. The power supply unit 390 may receive electric power from a power source (for example, a battery) included in the vehicle 10 and, as such, may supply electric power to each unit of the shared vehicle management device 100. The power supply unit 390 may operate in accordance with a control signal supplied from the main ECU 140. The power supply unit 390 may be embodied using a switched-mode power supply (SMPS).

The processor 370 may be electrically connected to the memory 340, the interface unit 280, and the power supply unit 390, and, as such, may exchange a signal therewith. The processor 370 may be embodied using at least one of application specific integrated circuits (ASICs), digital signal processors (DSPs), digital signal processing devices (DSPDs), programmable logic devices (PLDs), field programmable gate arrays (FPGAs), controllers, microcontrollers, microprocessors, or electrical units for execution of other functions.

The processor 370 may be driven by electric power supplied from the power supply unit 390. In a state in which electric power from the power supply unit 390 is supplied to the processor 370, the processor 370 may receive data, process the data, generate a signal, and supply the signal.

The processor 370 may receive information from other electronic devices in the vehicle 10 via the interface unit 380. The processor 370 may supply a control signal to other electronic devices in the vehicle 10 via the interface unit 380.

The processor 370 may receive an allocation request signal of the shared vehicle 10 from the user terminal 3. The allocation request signal may include information as to the user, and information as to a path along which the user will move. The information as to the user may include at least one of personal information of the user or position information of the user. The information as to the user movement path may include information as to at least one of a predetermined vehicle entrance point of the user, a passing point, or a destination.

The processor 370 may determine a vehicle to be allocated based on first traveling path information included in the allocation request signal. The first traveling path may be a path from a start point requested by the user to an end point requested by the user. The start point may be explained as a predetermined vehicle entrance point of the user. The end point may be explained as a destination. The processor 370 may determine a danger level of the first traveling path. Paths may be classified into plural levels based on at least one of kinds of sections included in the paths (for example, a curve, an uphill, a downhill, a crossroads, an entrance pathway, an exit pathway, etc.), volume of traffic, or past accident records. The plural levels may be continuously updated based on data received from a plurality of vehicles. The plural levels may be stored in the memory 340. The processor 370 may determine a vehicle to be allocated, based on which level from among a plurality of predetermined levels corresponds to the danger level of the first traveling path. For example, when the danger level is a high level, the processor 370 may allocate a manned manual vehicle. For example, when the danger level is a middle level, the processor 370 may allocate a manned autonomous vehicle. For example, when the danger level is a low level, the processor 370 may allocate a fully autonomous vehicle.

Meanwhile, the processor 370 may determine a pick-up point of the user, and may acquire a second traveling path from the start point of the vehicle to a pick-up point of the user. The pick-up point of the user may be explained as the predetermined vehicle entrance point of the user. The pick-up point of the user may be explained as the start point of the first traveling path. The start point may be explained as a point of the vehicle 10 at a time when the vehicle 10 receives a command for movement to the pick-up point from the vehicle management device 2. For example, the start point may be a garage. The processor 370 may determine a vehicle to be allocated further based on information as to the second traveling path. For example, when the danger level of the second traveling path is higher than a reference value, the processor 370 may allocate a manned autonomous vehicle.

When a manned autonomous vehicle is determined to be a vehicle to be allocated, the processor 370 may authenticate driving qualification of the user for a manned autonomous vehicle. The processor 370 may authenticate driving qualification of the user based on whether the user holds a manned autonomous vehicle license, whether the user holds a manual driver license or whether the user has completed driving-assistance tutorial course. Upon determining that the user holds a manned autonomous vehicle license, the processor 370 may determine that there is driving qualification of the user for an autonomous vehicle. Upon determined that the user holds a manual driver license, the processor may determine that there is driving qualification of the user for an autonomous vehicle. Upon determining that the user has completed a driving-assistance tutorial course, the processor may determine that there is driving qualification of the user for an autonomous vehicle in at least a part of sections.

The processor 370 may provide a passenger-assistance autonomous vehicle option. The passenger-assistance autonomous vehicle option may be understood as an option allowing the passenger to perform a driver function in a manned autonomous vehicle. When the passenger-assistance autonomous vehicle option is provided, the service providing company provides an autonomous vehicle including no driver to the user and, as such, the user may perform a driver function for the autonomous vehicle.

When at least one condition is satisfied, the processor 370 may provide the passenger-assistance autonomous vehicle option. For example, upon determining that the danger level of the second traveling path is not higher than the reference value, the processor 370 may provide the passenger-assistance autonomous vehicle option. The second traveling path may be explained as a path from a start point of the vehicle to a user pick-up point. When the danger level of the second traveling path is high, the autonomous vehicle may move to the pick-up point in a state of including a driver therein. For example, the processor 370 may acquire state information of the user, and may determine whether the user can perform driving, based on the state information. Upon determining that the user can perform driving, the processor 370 may provide the passenger-assistance autonomous vehicle option.

When driving qualification of the user is authenticated, the processor 370 may provide the passenger-assistance autonomous vehicle option. For example, when a manual driver license is authenticated in accordance with authentication of a manual driver license of the user, the processor 370 may provide the passenger-assistance autonomous vehicle option. For example, the processor may determine whether the user has completed a driving-assistance tutorial course. Upon determining that the user has completed a driving-assistance tutorial course, the processor 370 may issue a driving allowance grade for a part of sections in association with the user. Upon determining that the user has completed a driving-assistance tutorial course, the processor 370 may provide the passenger-assistance autonomous vehicle option.

On the other hand, when no driving qualification of the user is authenticated, the processor 370 may provide a manned autonomous vehicle option.

A situation in which driving of the passenger is required during traveling of the vehicle 10 may occur. In this case, the processor 370 may provide, to the vehicle 10, an information message as to a cause of requirement of driving of the passenger. The information message may include at least one of a message informing of verification of updated software, a message informing of an update situation of software, a message informing of a section exhibiting a high probability of sensor malfunction, or a message informing of a communication shadow section.

During traveling, the vehicle 10 may deviate from a predetermined autonomous path due to manual driving of the user. The processor 370 may determine whether the vehicle 10 deviates from a predetermined autonomous path due to manual driving of the user. Upon determining that the vehicle 10 deviates from a predetermined autonomous path due to manual driving of the user, the processor 370 may reset i) a path exhibiting a highest capability of unmanned autonomous travel from a deviated point to a destination or ii) a rapidest autonomous path from the deviated point to the destination.

The shared vehicle management device 2 may include at least one printed circuit board (PCB). The memory 340, the interface unit 380, the power supply unit 390 and the processor 370 may be electrically connected to the printed circuit board.

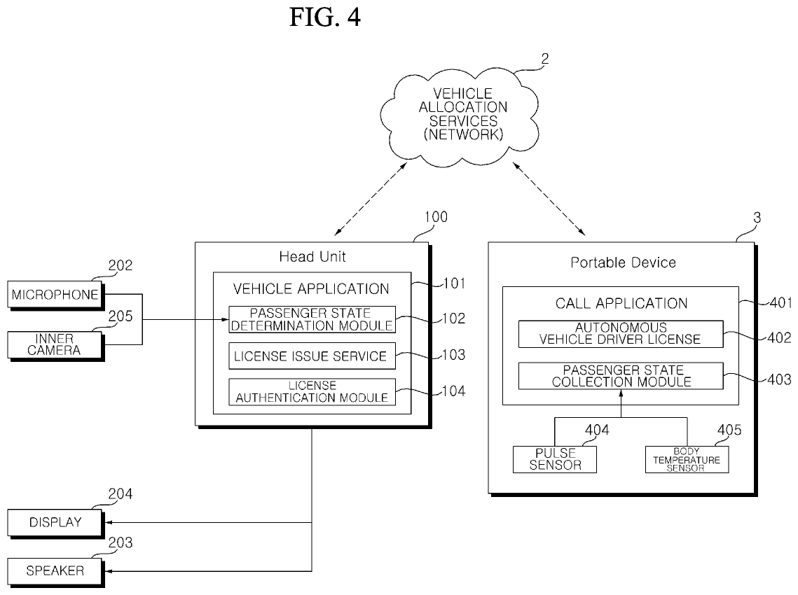

FIG. 4 is a diagram referred to for explanation of the system according to an embodiment of the present invention.

Referring to FIG. 4, in accordance with an embodiment, the shared vehicle management device 2 may be explained as a network for vehicle allocation services. The electronic device 100 may be explained as a head unit. The user terminal 3 may be explained as a portable device.

The electronic device 100 may include a vehicle application 101 for shared vehicle management. The vehicle application 101 may include a user state determination unit 102, a license issue unit 103, and a license authentication unit 104.

The user state determination unit 102 may monitor the user based on an inner vehicle compartment image acquired from an inner camera 205. The user state determination unit 102 may determine a state of the user. The user state determination unit 102 may determine whether the user can perform driving.

Upon determining that the user has completed a driving-assistance tutorial course, the license issue unit 103 may issue a driver license of the user.

The license authentication unit 104 may authenticate a manual driver license of the user. The license authentication unit 104 may receive manual driver license information from the user terminal 3.

The electronic device 100 may be electrically connected to a microphone 202, the inner camera 205, and a display 204. The electronic device 100 may implement a human machine interface (HMI), using at least one of the microphone 202, the inner camera 205, the speaker 203 or the display 204. The microphone 202 may convert a sound into an electrical signal. The inner camera 205 may acquire an inner vehicle compartment image. The speaker 203 may convert an electrical signal into a sound. The display 204 may output visual information based on an electrical signal.

The user terminal 3 may include a call application 401. The call application 401 may receive user input for vehicle allocation request. The call application 401 may send a call signal to the shared vehicle management device 2.

The call application 401 may include an autonomous vehicle driver license 402 and a user state collection unit 403. The autonomous vehicle driver license 402 may be a manual driver license for an autonomous vehicle. The user state collection unit 403 may receive sensing data from sensors 404 and 405 included in the user terminal 3, thereby determining a state of the user.

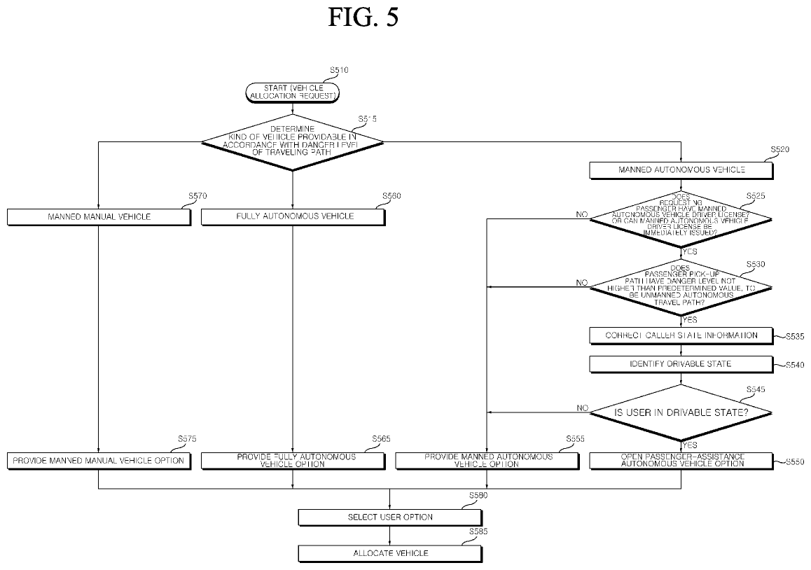

FIG. 5 is a flowchart referred to for explanation of a management method S500 for a shared vehicle according to an embodiment of the present invention.

Referring to FIG. 5, the processor 370 may receive a vehicle allocation request signal (S510). The vehicle allocation request signal may include information as to a first traveling path. The first traveling path may be a path from a start point requested by the user to an end point requested by the user. The processor 370 may determine a vehicle to be allocated, based on the first traveling path information included in the vehicle allocation request signal (S515). The step S515 of determining a vehicle to be allocated may include steps of determining, by at least one processor 370, a danger level of the first traveling path, and determining, by at least one processor 370, the vehicle to be allocated, based on which level from among a plurality of predetermined levels corresponds to the danger level of the first traveling path.

The processor 370 may determine a manned autonomous vehicle to be a vehicle to be allocated (S520). Upon determining a manned autonomous vehicle to be a vehicle to be allocated, the processor 370 may authenticate a driving qualification of the user for a manned autonomous vehicle (S525). The step S525 of authenticating a driving qualification may include a step of authenticating, by at least one processor 370, a manual driver license of the user. The step S525 of authenticating a driving qualification may include steps of determining, by at least one processor 370, whether the user has completed a driving-assistance tutorial course, and issuing, by at least one processor 370, a driving allowance grade for a part of sections in association with the user.

The processor 370 may determine whether a second path is a path allowing unmanned autonomous travel, based on information as to the second path (S530). The processor 370 may determine whether the second path is a path allowing unmanned autonomous travel, based on a danger level of the second path. The step S530 of determining whether the second path is a path allowing unmanned autonomous travel may include steps of determining, by at least one processor 370, a pick-up point of the user, and acquiring, by at least one processor 370, information as to a second traveling path from a start point of the vehicle to the pick-up point.

Upon determining that the danger level of the second path is not higher than a reference value, thereby determining that the second path is a path allowing unmanned autonomous travel, the processor 370 may acquire state information of the user (S535). The processor 370 may identify a drivability state of the driver based on the state information (S540), and may then determine whether the user can perform driving (S545).

The processor 370 may provide a passenger-assistance autonomous vehicle option (S550). When at least one condition is satisfied, the processor 370 may provide a passenger-assistance autonomous vehicle option. For example, upon determining, in step S530, that the danger level of the second traveling path is not higher than the reference value, the providing step S550 may provide a passenger-assistance autonomous vehicle option. For example, upon determining, in step S545, that the user can perform driving, the providing step S550 may provide a passenger-assistance autonomous vehicle option. For example, upon determining, in step S525, that a manual driver license is authenticated, the providing step S550 may provide a passenger-assistance autonomous vehicle option. For example, upon determining, in step S525, that the user has completed a driving-assistance tutorial course, the providing step S550 may provide a passenger-assistance autonomous vehicle option.

Upon determining, in step S525, that no driving qualification of the user is authenticated, the processor 370 may provide a manned autonomous vehicle operation (S555). Upon determining, in step S530, that the second path is not a path allowing unmanned autonomous driving, the processor 370 may provide a manned autonomous vehicle operation (S555). Upon determining, in step S545, that the user is not in a drivable state, the processor 370 may provide a manned autonomous vehicle operation (S555).

The processor 370 may determine a fully autonomous vehicle to be a vehicle to be allocated (S560). In this case, the processor 370 may provide a fully autonomous vehicle option (S565).

The processor 370 may determine a manned manual vehicle to be a vehicle to be allocated (S570). In this case, the processor 370 may provide a manned manual vehicle option (S575).

The processor 370 may receive user input to select one of the provided operations (S580). The processor 370 may allocate a vehicle in accordance with an option selected by the user (S585).

Meanwhile, the shared vehicle management method S500 may further include a step of providing, by at least one processor 370, information message as to a cause requiring driving of the passenger, after step S585. The information message may be provided to the user interface device 200 via the communication device 220 of the vehicle 10. The user interface device 200 may output the information message. The information message may include at least one of a message informing of verification of updated software, a message informing of an update situation of software, a message informing of a section exhibiting a high probability sensor malfunction, or a message informing of a communication shadow section.

Meanwhile, upon determining that the vehicle deviates from a predetermined autonomous path due to manual driving of the user, the shared vehicle management method S500 may further include a step of resetting, by at least one processor 370, i) a path exhibiting a highest capability of unmanned autonomous travel from a deviated point to a destination or ii) a rapidest autonomous path from the deviated point to the destination, after step S585.

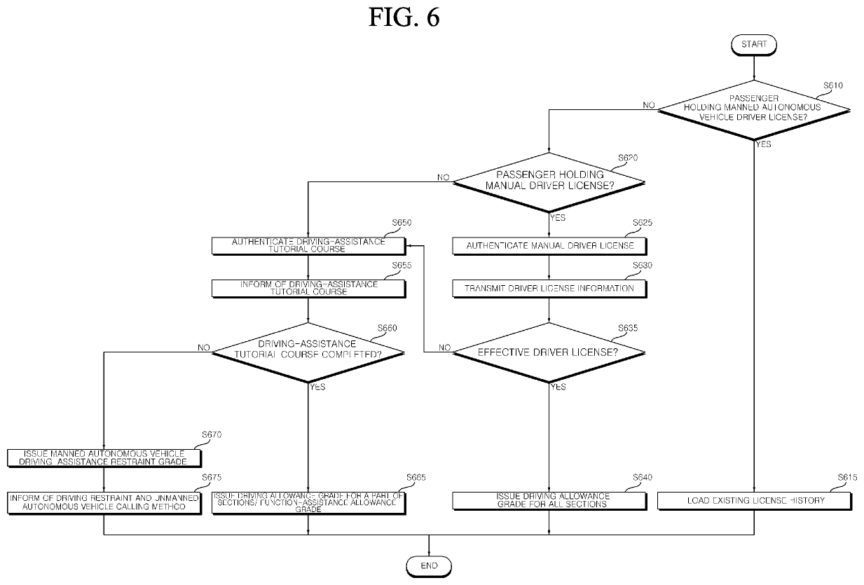

FIG. 6 is a flowchart referred to for explanation of a management method for a shared vehicle according to an embodiment of the present invention. FIG. 6 may be understood as a lower-level configuration of step S525 of FIG. 5.

Referring to FIG. 6, the processor 370 may determine whether the user holds a manned autonomous vehicle license (S610). Information as to a manned autonomous vehicle license may be included in a vehicle allocation request signal. In accordance with an embodiment, the processor 370 may request information as to a manned autonomous vehicle license of the user to the user terminal 3, and may receive the requested information. Upon determining that the user holds a manned autonomous vehicle license, the processor 170 may load an existing license history (S615).

Upon determining, in step S610, that the user does not hold a manned autonomous vehicle license, the processor 170 may determine whether the user holds a manual driver license (S620). Information as to a manual driver license may be included in a vehicle allocation request signal. In accordance with an embodiment, the processor 170 may request information as to a manual driver license of the user to the user terminal 3, and may receive the requested information. Upon determining that the user holds a manual driver license, the processor 170 may authenticate the manual driver license (S625), and may then transmit information as to the manual driver license to an authentication database (DB) (S630). The processor 170 may determine whether the manual driver license of the user is an effective driver license (S635). Upon determining that the manual driver license of the user is an effective driver license, the processor 170 may issue a driving allowance grade for all sections to the user (S640).

Upon determining, in step S620, that the user does not hold a manual driver license, the processor 170 may perform driving-assistance tutorial authentication (S650). The processor 170 may provide a driving-assistance tutorial information message (S655). The processor 170 may determine whether the user has completed a driving-assistance tutorial course (S660). Upon determining that the user has completed a driving-assistance tutorial course, the processor 370 may issue a driving allowance grade for a part of sections (S665). Upon determining that the user has completed a driving-assistance tutorial course, the processor 370 may issue a function-assistance allowance grade for a part of sections (S665).

Upon determining, in step S660, that the user does not complete a driving-assistance tutorial course, the processor 170 may issue a manned autonomous vehicle driving-assistance restraint grade (S670). In this case, the processor 170 may provide a driving restraint information message and an information message as to an unmanned autonomous vehicle calling method (S675).

The present invention as described above may be embodied as computer-readable code, which can be written on a program-stored recording medium. The recording medium that can be read by a computer includes all kinds of recording media, on which data that can be read by a computer system is written. Examples of recording media that can be read by a computer may include a hard disk drive (HDD), a solid state drive (SSD), a silicon disk drive (SDD), a read only memory (ROM), a random access memory (RAM), a CD-ROM, a magnetic tape, a floppy disk, an optical data storage, etc., and may include an embodiment having the form of a carrier wave (for example, transmission over the Internet). In addition, the computer may include a processor or a controller. Accordingly, it will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A management method for a shared vehicle comprising:
receiving, by at least one processor, a vehicle allocation request signal;
determining, by at least one processor, an allocated vehicle based on first traveling path information included in the vehicle allocation request signal;
authenticating, by at least one processor, driving qualification of a user for a manned autonomous vehicle when the manned autonomous vehicle is determined to be the allocated vehicle; and
providing, by at least one processor, a passenger-assistance autonomous vehicle option.

2. The management method for the shared vehicle according to claim 1, further comprising:
determining, by at least one processor, a pick-up point of the user; and
acquiring, by at least one processor, information as to a second traveling path from a start point of the vehicle to the pick-up point.

3. The management method for the shared vehicle according to claim 2, wherein the providing comprises of providing the passenger-assistance autonomous vehicle option when a danger level of the second traveling path is not higher than a reference value.

4. The management method for the shared vehicle according to claim 3, further comprising:
acquiring, by at least one processor, state information of the user; and
determining, by at least one processor, whether the user is able to perform driving, based on the state information.

5. The management method for the shared vehicle according to claim 4, wherein the providing comprises of providing the passage-assistance autonomous vehicle option when the user is determined to be able to perform driving.

6. The management method for the shared vehicle according to claim 1, further comprising:
providing, by at least one processor, a manned autonomous vehicle option when driving qualification of the user is determined not to be authenticated.

7. The management method for the shared vehicle according to claim 1, wherein the determining an allocated vehicle comprises:
determining, by at least one processor, a danger level of the first traveling path; and
determining, by at least one processor, the allocated vehicle, based on which level from among a plurality of predetermined levels corresponds to the danger level of the first traveling path.

8. The management method for the shared vehicle according to claim 1, wherein the authenticating driving qualification comprises of authenticating, by at least one processor, a manual driver license of the user; and
wherein the providing comprises of providing a passenger-assistance autonomous vehicle option when the manual driver license is authenticated.

9. The management method for the shared vehicle according to claim 1, wherein the authenticating driving qualification comprises:
determining, by at least one processor, whether the user has completed a driving-assistance tutorial course, and
issuing, by at least one processor, a driving allowance grade for a part of sections in association with the user; and
wherein the providing comprises of providing a passenger-assistance autonomous vehicle option when the user is determined to have completed a driving-assistance tutorial course.

10. The management method for the shared vehicle according to claim 1, further comprising:
providing, by at least one processor, an information message as to a cause of requirement of driving of a passenger,
wherein the information message comprises at least one of messages, the messages including a message informing verification of updated software, a message informing an update situation of software, a message informing a section exhibiting a high probability of sensor malfunction, or a message informing a communication shadow section.

11. The management method for the shared vehicle according to claim 1, further comprising:
resetting, by at least one processor, i) a path exhibiting a highest capability of unmanned autonomous travel from a deviated point to a destination or ii) a rapidest autonomous path from the deviated point to the destination when the vehicle is determined to deviate from a predetermined autonomous path due to manual driving of the user.

12. A shared vehicle management device comprising:
at least one processor is configured to:
receive a vehicle allocation request signal,
determine an allocated vehicle based on first traveling path information included in the vehicle allocation request signal,
authenticate driving qualification of a user for a manned autonomous vehicle when the manned autonomous vehicle is determined to be the allocated vehicle, and
provide a passenger-assistance autonomous vehicle option.

13. The shared vehicle management device according to claim 12, wherein the processor is configured to determine a pick-up point of the user, and acquire information as to a second traveling path from a start point of the vehicle to the pick-up point.

14. The shared vehicle management device according to claim 13, wherein the processor is configured to provide the passenger-assistance autonomous vehicle option when a danger level of the second traveling path is not higher than a reference value.

15. The shared vehicle management device according to claim 14, wherein the processor is configured to:
acquire state information of the user,
determine whether the user is able to perform driving, based on the state information; and
provide the passage-assistance autonomous vehicle option when the user is determined to be able to perform driving.

16. The shared vehicle management device according to claim 12, wherein the processor is configured to provide a manned autonomous vehicle option when driving qualification of the user is determined not to be authenticated.

17. The shared vehicle management device according to claim 12, wherein the processor is configured to:
determine a danger level of the first traveling path; and
determine a vehicle to be allocated, based on which level from among a plurality of predetermined levels corresponds to the danger level of the first traveling path.

18. The shared vehicle management device according to claim 12, wherein the processor is configured to:
authenticate a manual driver license of the user; and
provide a passenger-assistance autonomous vehicle option when the manual driver license is authenticated.

19. The shared vehicle management device according to claim 12, wherein the processor is configured to:
determine whether the user has completed a driving-assistance tutorial course;
issue a driving allowance grade for a part of sections in association with the user; and
provide a passenger-assistance autonomous vehicle option when the user is determined to have completed a driving-assistance tutorial course.

20. The shared vehicle management device according to claim 12, wherein the processor is configured to provide an information message as to a cause of requirement of driving of a passenger; and
wherein the information message comprises at least one of messages, the messages including a message informing verification of updated software, a message informing an update situation of software, a message informing a section exhibiting a high probability of sensor malfunction, or a message informing a communication shadow section.
